(19) United States
(12) Patent Application Publication
(10) Pub. No.: US 2025/0349313 A1
(43) Pub. Date: Nov. 13, 2025

(54) DEVICE FOR MOUNTING A TONE ARM, IN PARTICULAR A TONE ARM OF A RECORD PLAYER

(71) Applicant: clearaudio electronic GmbH, Erlangen (DE)

(72) Inventors: Robert SUCHY, Erlangen (DE); Marko BOROVAC, Erlangen (DE)

(21) Appl. No.: 19/201,329

(22) Filed: May 7, 2025

(30) Foreign Application Priority Data
May 7, 2024 (DE) 10 2024 112 736.8

(51) Int. Cl. G11B 3/10

(52) U.S. Cl. CPC G11B 3/10

(57) ABSTRACT

A device for bearing a tone arm, in particular a tone arm of a record player, includes a first component and a tone arm holding body which is mounted via a bearing apparatus so as to be rotatable about a first axis, in particular a vertical axis, and pivotable relative to the first component about a second axis, in particular a horizontal axis. At least one first magnetic means is arranged or formed on the tone arm holding body and at least one second magnetic means is arranged or formed on the first component. The first magnetic means and the second magnetic means interact with one another via a magnetically attracting and/or repelling magnetic force.

### CROSS-REFERENCE TO RELATED APPLICATIONS

The present application claims priority of DE 10 2024 112 736.8, filed May 7, 2024, the priority of this application is hereby claimed, and this application is incorporated herein by reference.

### BACKGROUND OF THE INVENTION

Corresponding devices for mounting a tone arm are basically known from the state of the art. It is known, for example, to mount a tone arm on a so-called one-point bearing so that the tone arm can move as freely as possible and only slight resistance occurs during the guided contact of the tone arm by its stylus lying in a rotating record groove. The disadvantage here is that the one-point bearing can cause the tone arm to rock or wobble, as the tone arm is only supported by two point-shaped bearing points, one on the bearing apparatus of the tone arm on the turntable and one on the stylus in the record groove. Due to the unstable mounting of the tone arm, superimposed and/or rocking or periodic movements of the tone arm can occur, which have a detrimental effect on the scanning result or the generated sound signal.

### SUMMARY OF THE INVENTION

The invention is based on the object of providing a device for mounting a tone arm, which enables sufficient and stable guidance of the tone arm with low mechanical resistance when the tone arm is moved as intended.

The object is achieved by a device for mounting a tone arm, in particular a tone arm of a record player, according to claim 1. The claims dependent thereon relate to possible embodiments of the device. Further, the problem is solved by a method according to claim 15.

The invention relates to a device for mounting a tone arm, in particular a tone arm of a record player. The device comprises a first component and a tone arm holding body which is mounted on the first component so as to be rotatable about a first axis, in particular a vertical axis, and pivotable about a second axis, in particular a horizontal axis, via a bearing apparatus. This can therefore be a bearing for a so-called radial tone arm, i.e. a tone arm mounted so that it can rotate around a vertical axis. By rotating around the first axis, for example the vertical axis, the tone arm can be guided or moved in the groove of the scanned record during contact of the scanning body, in particular a stylus.

Due to the rotatable mounting of the tone arm over both a horizontal and a vertical axis or due to a one-point bearing of the tone arm, it tends to wobble around the bearing point. In order to stabilize the tone arm mounting, magnetic mounting or support of the tone arm is provided by means of the bearing apparatus in addition to the single-point bearing or point bearing. For this purpose, at least one first magnetic means is arranged or formed on the tone arm holding body and at least one second magnetic means is arranged or formed on the first component, wherein the first magnetic means and the second magnetic means interact with one another via a magnetically attracting and/or repelling magnetic force. Due to the fact that, in addition to the contacting bearing apparatus, an additional magnetic effect is exerted directly or indirectly on the tone arm or the tone arm body, wobbling of the tone arm body or the tone arm around the bearing apparatus bearing point can be prevented or dampened. This is achieved without increasing mechanical resistance for the rotational movement of the tone arm holding body or the tone arm about the first axis, in particular about the vertical axis. It should be noted here that the tone arm performs a rotational movement around the vertical axis during its intended operation and the magnetic interaction between the first and second magnetic means remains homogeneous over the rotational movement of the tone arm. This means that the effective magnetic forces between the first and second magnetic means do not lead to magnetic force-related irregularities in the rotational movement due to the rotational movement and thus due to an adjustment of the relative position of the first and second magnetic means—i.e. their rotation relative to one another. In other words, no increase in resistance or change in resistance, even temporary or depending on the angle of rotation, is caused by the interaction of the magnetic forces of the first and second magnetic means during the intended rotational movement of the tone arm or during the intended rotational movement between the tone arm holding body and the first component. This allows the magnetic force or magnetic flux, which is present in a gap between the first and second magnetic means due to the first and second magnetic means, to be constant over the rotational movement of the tone arm holding body relative to the first component. In particular, a relative movement between the first and second magnetic means takes place during the intended rotational movement of the tone arm and/or the tone arm holding body, wherein this does not lead to a change in the acting magnetic forces of the magnetic means, so that a smooth rotation without rotational resistance fluctuations is made possible.

It is possible that the first component is arranged below the tone arm holding body. The fact that the first component is arranged below the tone arm holding body means that the first magnetic means can be arranged low down so that they do not impair the overall visual impression of the tone arm holding body and/or the first magnetic means are protected from dust and external mechanical influences. Thus, the first component is covered or protected at least in portions by the tone arm holding body, at least on the upper side. A compact arrangement can also be achieved, as the height can be staggered so that the first component is arranged at least predominantly in the vertical axis and the tone arm holding body is arranged at least predominantly towards the top.

The first component can, for example, have a receiving recess in which the tone arm holding body can be received at least in portions. Due to the fact that the tone arm holding body protrudes or enters at least in portions into a receiving recess of the first component, a parting joint between the tone arm holding body and the first component can have a shape deviating from a straight line. In other words, the parting joint can have a geometry that deviates from a plane, so that a closure or a labyrinth-like structure of the parting joint results in the manner of interlocking portions, so that the penetration of foreign bodies or dust into the parting joint is prevented or made more difficult. A compact design of the device can also be achieved by accommodating the tone arm holding body, at least in portions, in a receiving recess of the first component.

The receiving recess can, for example, be designed as a groove, preferably as a ring groove, particularly preferably as a circular ring groove. This groove or ring groove can have an opening that faces the tone arm holding body and/or whose opening direction is aligned along an axis of rotation, in particular the first axis or the vertical axis, of the tone arm holding body or the bearing apparatus. A tone arm holding body designed at least in portions as a ring bead, in particular as a circular ring bead, can be accommodated in a receiving recess of the first component designed as a ring groove. The receiving recess and/or an immersion portion of the tone arm holding body that dips into the receiving recess can form a closed or partially interrupted ring, in particular a circular ring. A circular ring that is partially interrupted or has gaps can, for example, be formed by elements that are arranged on a circular ring line and have gaps between them on the circular ring line. It is possible that the receiving recess and/or the immersion portion of the tone arm holding body is/are symmetrical, in particular point-symmetrical and/or rotationally symmetrical. A radially inner boundary wall of the receiving recess can be higher or the same height as a radially outer boundary wall of the receiving recess.

It is possible that the first component is designed as a ring-shaped body. For example, the first component is designed as a circular ring-shaped body. The first component can, for example, have a symmetrical, in particular a point-symmetrical and/or rotationally symmetrical shape. It is possible that the first component has a point and/or rotational symmetry about the first axis, in particular about the vertical axis, of the bearing apparatus.

The first component can, for example, be arranged or designed to be immobile or rigid with a bearing apparatus. This means, for example, that the first component is attached to a base of a record player (a) rotatably and lockably and thus at least temporarily immovably and rigidly or (b) non-rotatably. This allows the first component to be arranged or formed on a record player base in a technically simple and cost-effective manner. The record player base is the component of a record player that provides support to the surface on which the record player is placed. For example, the base of the record player can be a ground frame on which a turntable and the tone arm are rotatably mounted.

The first magnetic means and/or the second magnetic means can, for example, have at least two magnetic elements. By using more than one magnetic element for the first and/or second magnetic means, the effective magnetic force or the effective magnetic field can be increased in a simple and convenient way. It is also possible to specify a specific direction of action of the magnetic forces by arranging more than one magnet for the first and/or second magnetic means. This also prevents overdimensioning of the magnetic forces present, as magnetic forces are targeted where they are needed to stabilize the mounting of the tone arm.

It is possible that the magnetic forces emanating from the first and second magnetic means act symmetrically to the first axis, in particular to the axis of rotation of the tone arm holding body. This means, for example, that the first magnetic means and the second magnetic means are each arranged or designed symmetrically to the first axis, in particular point-symmetrically to the first axis, in order to exhibit two magnetic forces, preferably canceling one another out in their sum, on a straight line intersecting the first axis, in particular perpendicularly, during a rotational movement of the tone arm holding body. Thus, a magnetic force emanating in a first radial direction of the tone arm holding body can cancel out with a second magnetic force pointing in a radial direction opposite to the first radial direction, i.e. the force amounts are the same, but the force vectors point in opposite directions.

Alternatively or additionally, at least a first and a second magnetic element of the first magnetic means or at least a first and a second magnetic element of the second magnetic means can be arranged or formed symmetrically to one another, in particular point-symmetrically and/or mirror-symmetrically. The symmetrical arrangement of the at least two magnetic elements of the first and/or second magnetic means can, for example, comprise a symmetry, in particular a point or rotational symmetry, to the first axis, i.e. for example to the vertical axis, of the bearing apparatus.

It is possible that the first or second magnetic means is designed as a one-piece disk-shaped or ring-shaped body, in particular as a circular disk or as a circular ring-shaped body. This allows a homogeneous magnetic effect of the correspondingly formed magnetic means to be achieved via the rotational movement of this magnetic means relative to the other magnetic means. For this purpose, the axis of rotation of the relative rotational movement of the first and second magnetic means is arranged coaxially to a central axis, in particular an axis of symmetry, of the at least one disc-shaped or ring-shaped magnetic means.

The first magnetic means and/or the second magnetic means can, for example, comprise at least one magnetic element, preferably comprising a plurality of magnetic elements, wherein the at least one magnetic element has an elongate shape with a longitudinal axis, wherein the longitudinal axis includes an angle α between 5° and 175°, preferably 40° and 140°, particularly preferably 60° and 120°, most preferably 70° to 110°, with an axis of rotation (vertical axis). If a plurality of elongated magnetic elements are used, these can each include an angle in the specified value ranges a with the first axis, i.e. with the vertical axis. By tilting the magnetic elements in this way, the magnetic field emanating from these magnetic elements is brought into an advantageous alignment with the spaced-apart and interacting magnetic means. In other words, the at least one magnetic element of the first magnetic means is arranged in the tone arm holding body in such a way that its end face faces the second magnetic element or is aligned with it. This aligns and/or positions the magnetic field generated by the at least one magnetic element of the first magnetic means towards a maximum magnetic interaction with the second magnetic means.

Alternatively or additionally, the first magnetic means and/or the second magnetic means may comprise at least one, preferably a plurality of, magnetic element(s), wherein the at least one magnetic element has an elongate shape with a longitudinal axis, wherein the longitudinal axis is aligned at an angle β to a horizontal line and the angle β is in the range between 1.5° and 45°, preferably 2° and 35°, particularly preferably 5° and 30°, most preferably 10° to 25°, further preferably 12.5° and 20°. Preferably, the longitudinal axis of the at least one magnetic element is aligned to slope downwards radially outwards. This correspondingly inclined alignment of the magnets on the tone arm holding body or to an axis of rotation or horizontal axis can enable advantageous stabilization of the tone arm holding body without increasing any mechanical resistance during twisting of the tone arm holding body.

The tone arm holding body can, for example, have a receiving space for receiving a component of the bearing apparatus, wherein the receiving space is delimited by a wall portion of the tone arm holding body and the first magnetic means is arranged or formed at least in portions, preferably predominantly, particularly preferably completely, on, i.e. in or on, a wall portion. In other words, the tone arm holding body forms a receiving space, wherein the magnetic means on the tone arm holding body side is arranged at least in portions in the area of the receiving space. Preferably, the first magnetic means is arranged or formed at least in portions, preferably predominantly, particularly preferably completely, on an edge area of the wall portion associated with an opening of the receiving space. The tone arm holding body can, for example, have a pot or bell shape at least in portions, wherein the interior of the pot and/or bell shape forms the receiving space in which at least one component of the bearing apparatus is arranged in portions.

In an optional embodiment, it may be provided that the tone arm holding body has a receiving space for receiving a component of the first component. For example, the receiving space of the tone arm holding body can accommodate both a component of the bearing apparatus and a component of the first component, or the bearing apparatus and the first component can project into the receiving space at least in portions.

For example, the receiving space is delimited by a wall portion of the tone arm holding body, wherein the wall portion, in particular in the final assembly state and/or during the intended operation of the device, is arranged at least in portions in a receiving recess of the first component. In other words, both the tone arm holding body and the first component have a recess into which a portion of the other projects or engages. This engagement forms a continuous gap, i.e. there is no contact between the tone arm holding body and the first component during this engagement. This ensures unhindered relative movement of the tone arm holding body and the first component.

The first magnetic means and/or the second magnetic means can comprise at least two magnetic elements designed as permanent magnets. This means that the first and/or the second magnetic means can comprise at least two magnetic elements that are separate from one another, arranged at a distance from one another and each designed as a permanent magnet. Preferably, all magnetic elements of the first magnetic means or the second magnetic means are designed as permanent magnets. The fact that a magnetic means has more than two, preferably more than three, particularly preferably more than four, most preferably more than five, spaced-apart magnetic elements means that their arrangement can be used to achieve contactless or magnetic field-based support of the tone arm holding body against any wobbling behavior, depending on the area and the potential wobbling behavior of the tone arm holding body. For example, the magnetic elements of a magnetic means are arranged in at least two groups of magnetic elements on the tone arm holding body and/or on the first component. The at least one first and the at least one second group of magnetic elements of the first and/or second magnetic means can, for example, be arranged or formed symmetrically, in particular point-symmetrically or axially symmetrically, in particular mirror-symmetrically, on the tone arm holding body and/or on the first component.

It is possible that the first magnetic means comprises at least one magnetic element designed as a permanent magnet and the second magnetic means comprises no permanent magnets or no magnetic element designed as a permanent magnet. Alternatively, the second magnetic means can comprise at least one magnetic element designed as a permanent magnet and the first magnetic means can be free of permanent magnets or not comprise a magnetic element designed as a permanent magnet. Due to the fact that only either the first or the second magnetic means comprises magnetic elements designed as permanent magnets, the other magnetic means can be a magnetic means that can only be magnetized passively, i.e. via the magnetic effect of the permanent magnet. This reduces costs, as steel, for example, can be used for the non-permanent magnetic means, wherein this magnetic means quickly loses its magnetic property as soon as the magnetic field acting from the other magnetic means, the permanent magnet, is removed. In other words, a permanent magnet is a magnet or a material that retains its magnetization for a long time after magnetization, whereas a non-permanent magnet loses its magnetization within a short time after magnetization or the magnetic effect is no longer present. For example, a magnetic means designed as a permanent magnet may consist of one of the following materials: (a) rare earths such as neodymium, samarium cobalt or other rare earths; (b) ceramics or ferrites; (c) alnico (aluminum, nickel and cobalt); or (d) other magnetic materials that currently exist or will be developed in the future that perform the same function. The function is to create an attractive force that exerts a suction effect on the other magnetic means. The magnetic means are not in physical contact with one another.

In addition to the device, the invention relates to a method for mounting a tone arm, in particular a tone arm of a record player, by means of a device described herein. Here it is intended that a first component is provided, wherein a second magnetic means is arranged or formed on the first component. Further, a tone arm holding body is provided, wherein a first magnetic means is arranged or formed on the tone arm holding body. The tone arm holding body is then arranged in such a way (a) that the tone arm holding body is mounted on a bearing apparatus and (b) that the first magnetic means and the second magnetic means interact with one another via a magnetically attracting and/or repelling magnetic force. The first component can be magnetic or magnetizable at least in portions, preferably predominantly, particularly preferably completely, and thus form the second magnetic means. Alternatively or additionally, the tone arm holding body can be magnetic or magnetizable at least in portions, preferably predominantly, particularly preferably completely, and thus form the first magnetic means. Optionally or alternatively, a magnetic element, in particular a magnetic element designed as a permanent magnet, can be attached to the tone arm holding body and/or to the first component, in particular by means of a force-fit and/or form-fit and/or material-fit attachment.

All advantages, details, designs and/or features of the device according to the invention are transferable or applicable to the method according to the invention and vice versa.

### BRIEF DESCRIPTION OF THE DRAWING

The invention is explained in more detail with reference to embodiments in the drawings. In the figures:

FIG. 1 is a perspective view in full section of a device according to an embodiment example;

FIG. 2 is a schematic exploded view of individual components of a device as shown in FIG. 1;

FIG. 3 is a perspective view of a tone arm holding body according to an embodiment example;

FIG. 4 is a perspective view of a tone arm holding body according to FIG. 3, rotated by 90° relative to FIG. 3;

FIG. 5 is a bottom view of a tone arm holding body provided with a tone arm;

FIG. 6 is a schematic full sectional view of a tone arm holding body according to FIG. 3;

FIG. 7 is a schematic partial sectional view of a device as shown in FIG. 1.

### DETAILED DESCRIPTION OF THE INVENTION

The figures show a device 1 for mounting a tone arm 2, in particular a tone arm 2 of a record player (not shown). The device comprises a first component 3 and a tone arm holding body 4. The tone arm holding body 4 is rotatable about a first axis 6, in particular a vertical axis, and pivotable about a second axis 7, in particular about a horizontal axis, relative to the first component 3 via a bearing apparatus 5. Thus, the tone arm 2 or the tone arm holding body 4 is also rotatable relative to a turntable (not shown) or to a record resting on a turntable (not shown) about the first axis 6 and pivotable about at least one horizontal axis, in particular about two horizontal axes aligned perpendicular to one another and lying in a horizontal plane. This design is also referred to as a radial tone arm concept, meaning that the tone arm performs a rotational movement in relation to the record during its intended operation.

At least one first magnetic means 8 is arranged or formed on, i.e. for example in or on, the tone arm holding body 4 and at least one second magnetic means 9 is arranged or formed on, i.e. for example in or on, the first component 3. This results in a magnetic interaction between the first magnetic means 8 and the second magnetic means 9 via a magnetically attracting and/or repelling magnetic force.

In the embodiment shown in the figures, the bearing apparatus 4 comprises a single-point bearing, i.e. a bearing of the tone arm holding body 4 via a contact point. For this purpose, a rod-shaped bearing means, e.g. a bearing needle 22, is fixed to a bearing base body 23, wherein a bearing tip of the bearing needle 22 facing the tone arm holding body 4 comes into point contact in a bearing needle receptacle 24 fixed in the tone arm holding body 4. The bearing needle receptacle 24 and/or the bearing needle 22 can be formed from a material exhibiting low mechanical friction, for example the bearing needle receptacle and/or the bearing needle 22 can consist at least in portions of a precious stone, in particular sapphire, or comprise a body made of sapphire. Thus, the contact of the bearing means of the tone arm holding body 4 and the bearing apparatus 5 can comprise at least one bearing stone. For example, a first bearing partner can be made of steel or a bearing stone and the second bearing partner can be made of a bearing stone. The use of bearing stones reduces wear and increases the uniform transmission of force during movement of the bearing. For example, it may be provided that the bearing needle receptacle 24 comprises a receiving hole into which the bearing tip of the bearing needle 22 penetrates at least in portions. Alternatively, a single-point bearing can be designed as a ball joint. In general, the bearing can, for example, enable rotation along two spatial axes and absorb translational forces along at least two spatial axes or prevent corresponding movement. Optionally, the bearing apparatus can also absorb force via three translational degrees of freedom.

In the embodiment shown in the figures, the first component 3 is arranged below the tone arm holding body 4. Thus, the first component 3 is assigned or arranged at the lower end or at the end of the tone arm holding body 4 facing away from the tone arm receptacle 25. The tone arm receptacle 25 is designed as a channel portion of the tone arm holding body 4, into which the tone arm 2 can be accommodated. For example, the tone arm 2 can be fixed in the tone arm receptacle 25 by means of a clamping force.

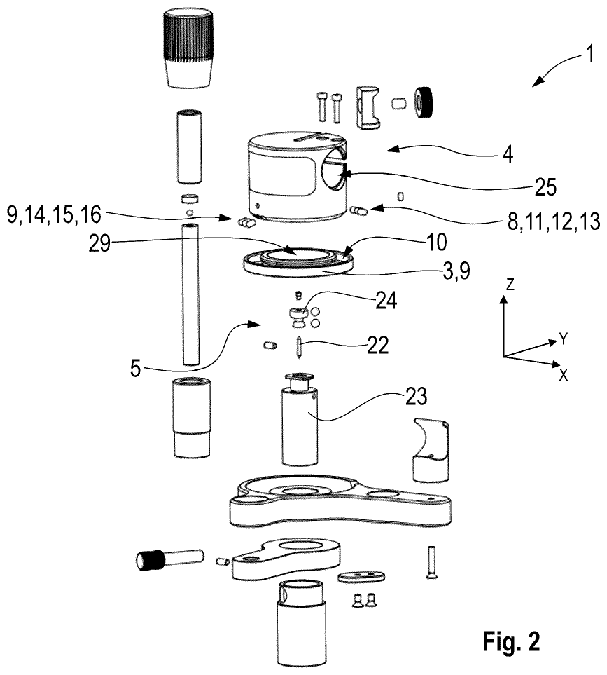

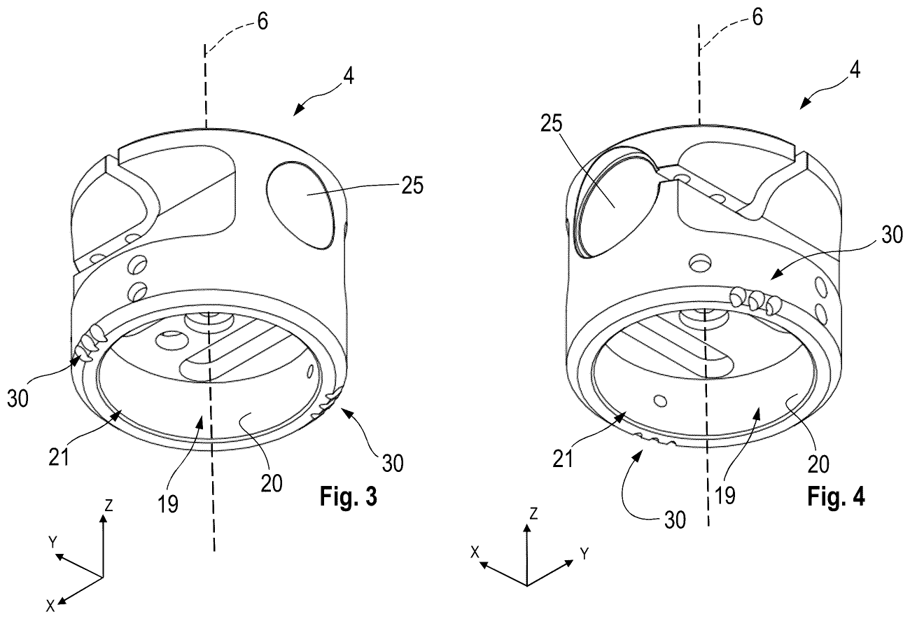

The first component 3 can, for example, be formed at least in portions, preferably predominantly, particularly preferably completely, as a second magnetic means 9. In the embodiment shown in FIG. 2, the first component 3 itself is the second magnetic means 9. In other words, the first component 3 itself acts at least in portions, preferably predominantly, particularly preferably completely, as a magnet and thus as a second magnetic means 9. In this case, the material of the first component 3 is preferably selected such that it is itself magnetic or magnetizable, such that in the intended operation of the device 1, due to the first and second magnetic means 8, 9 and/or other auxiliary means (e.g. an electromagnet), a magnetic force is established between the first and second magnetic means 9, which has a stabilizing effect on the mounting of the tone arm holding body 4. For example, the first component 3 can be designed as a one-piece metal ring which, due to the provision of at least one permanent magnet as magnetic element 11, 12, 13, 14, 15, 16 of the first magnetic means 8 or as magnetic element 11, 12, 13, 14, 15, 16 on the tone arm holding body side, induces a magnetic effect in the first component 3 or in the metal ring and consequently a magnetic force is formed between the first magnetic means 8 and the second magnetic means 9 or the first component 3.

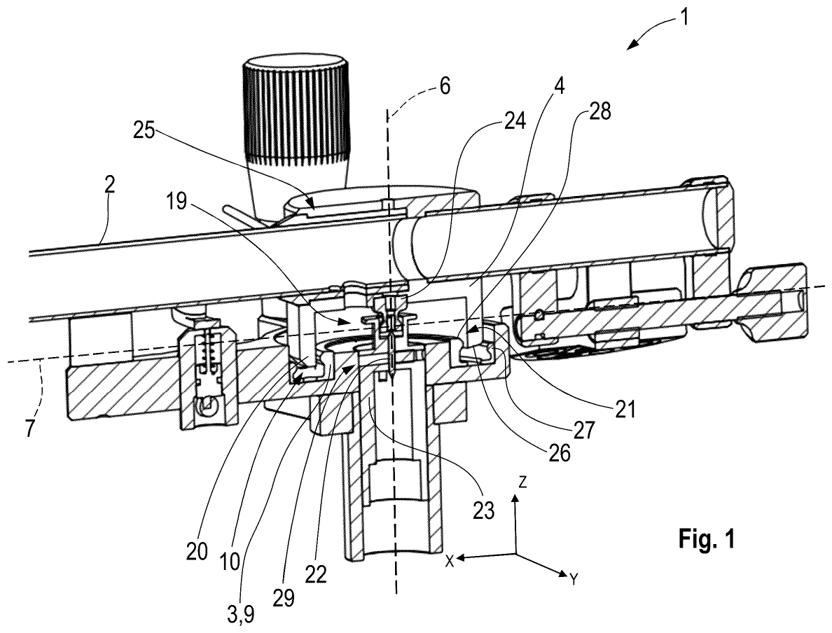

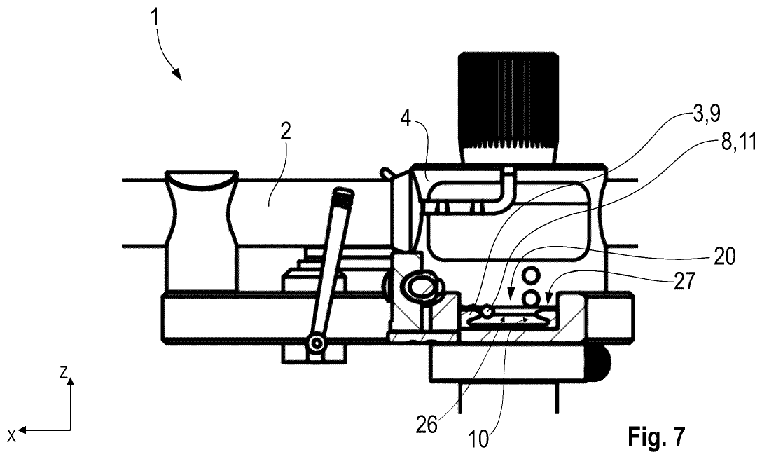

The first component 3 has a receiving recess 10 into which the tone arm holding body 4 can be received at least in portions. The receiving recess 10 is designed, for example, as a ring groove, in particular a circular ring groove, wherein a ring bead on the tone arm holding body side, in particular a circular ring bead of the tone arm holding body 4, projects into the receiving recess 10. In the illustration shown in FIG. 7, the cutting plane of the figure is positioned such that it is parallel to the first axis 6 and in the close area next to the tone arm holding body 4, so that the tone arm holding body 4 is not cut, but the first component 3 is cut in the close area of the tone arm holding body 4. It can be seen that the lower edge 26 of the tone arm holding body 4 is positioned below an upper edge 27, 28 of the first component 3. The upper edge 27 can relate to the radially outer upper edge 27 of the first component 3, while the upper edge 28 can relate to the radially inner upper edge 28 of the first component 3. The upper edges 27, 28 can, for example, form absolute or relative maxima of the height extension of the first component 3. Preferably, the radially inner upper edge 28 of the first component 3 is higher than the radially outer upper edge 27 of the first component 3, see FIG. 1. The receiving recess 10 can be formed between the radially inner upper edge 27 and the radially outer upper edge 28.

The first component 3 can, for example, be designed as a circular body. In the figures, the first component 3 is exemplarily designed as a circular ring-shaped body, which has a central aperture 29. The bearing needle 22 and/or a bearing base body 23 can be arranged at least in portions within the aperture 29. Preferably, the bearing needle 22 and/or the bearing base body 23 is secured in the aperture 29, in particular in a non-rotatable manner. This means that no rotational movement can be carried out between the bearing base body 23 and/or the bearing needle 22 on the one hand and the first component 3 on the other, at least temporarily, preferably always. An at least temporarily enabled or disabled mobility can be made possible, for example, by means of a locking mechanism that can be activated and deactivated. In other words, the first component 3 may be immovably or rigidly arranged or formed or fixed with a bearing apparatus 5. In this case, the components of the bearing apparatus 5 assigned to the first component 3 are considered.

The first magnetic means 8 and/or the second magnetic means 9 can, for example, have at least two magnetic elements 11, 12, 13, 14, 15, 16. In the embodiments shown in the figures, the second magnetic means 9 is designed as a one-piece ring body, which is itself magnetic or magnetizable and thus forms the second magnetic means 9. The tone arm holding body 4 has at least two, in particular cylindrical, magnetic elements 11, 12, 13, 14, 15, 16. In the example, magnetic elements 11, 12, 13, 14, 15, 16 are designed as circular cylindrical bodies. In particular, at least one magnetic element, in particular all magnetic elements 11, 12, 13, 14, 15, 16, can be inserted at least in portions into receiving holes 30 formed on an outwardly facing or inwardly facing surface of the tone arm holding body 4. The at least one receiving hole 30 can, for example, be designed as a through hole or a blind hole.

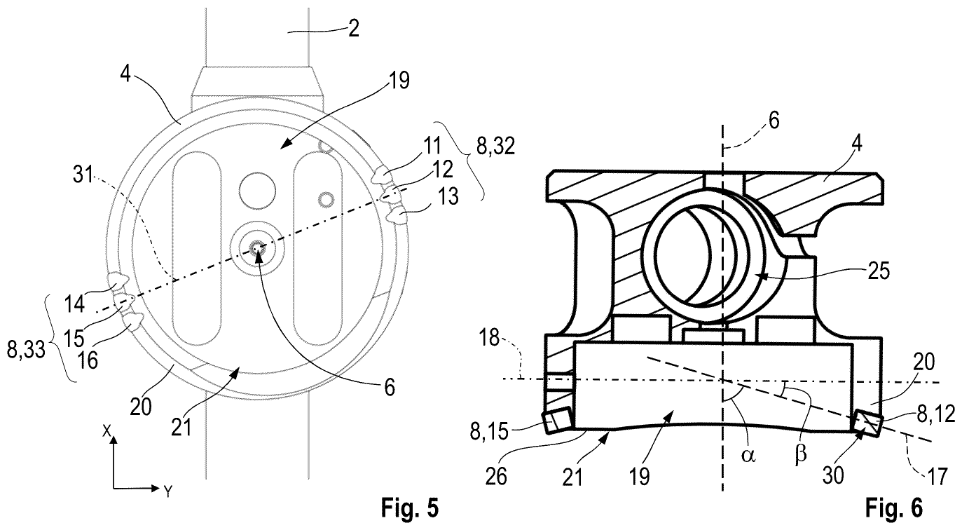

In a preferred embodiment, for example, (a) at least a first and a second magnetic element 11, 12, 13, 14, 15, 16 of the first magnetic means 8 or (b) at least a first and a second magnetic element 11, 12, 13, 14, 15, 16 of the second magnetic means 9 can be arranged or formed symmetrically, in particular point-symmetrically and/or mirror-symmetrically, with respect to one another. As can be seen in FIG. 5, for example, the at least two magnetic elements 11, 12, 13, 14, 15, 16 are arranged on the tone arm holding body 4 in a point-symmetrical manner around the center of rotation of the tone arm holding body 4. The rotationally symmetrical and/or point-symmetrical arrangement of the magnetic elements 11, 12, 13, 14, 15, 16 on the tone arm holding body 4 achieves a radially homogeneous or constant magnetic stabilization effect for the tone arm holding body 4 over a rotational movement of the tone arm holding body 4. In other words, the magnetic forces relating to a wobbling movement of the tone arm holding body 4 are distributed around the circumference of the tone arm holding body 4 in such a way that at least two magnetic elements 11, 12, 13, 14, 15, 16 simultaneously enable magnetic stabilization or magnetic support of the tone arm holding body 4. Here, two magnetic elements 11, 12, 13, 14, 15, 16, preferably all magnetic elements 11, 12, 13, 14, 15, 16 of the tone arm holding body 4 lie in pairs on a straight line on which the bearing point of the one-point bearing of the tone arm holding body 4 and/or which also intersects the first axis 6 (vertical axis), cf. straight line 31. The magnetic elements 13, 14 and the first axis 6 lie on the straight line 31.

Preferably, the tone arm holding body 4 has two groups 32, 33, which are each formed from more than two magnetic elements 11, 12, 13, 14, 15, 16, wherein the two groups 32, 33 are arranged or formed symmetrically to one another, preferably point-symmetrically and/or mirror-symmetrically to one another on the tone arm holding body 4, see FIG. 5. Optionally, it is possible that the at least two groups 32, 33 of magnetic elements 11, 12, 13, 14, 15, 16 are arranged or formed alternatively or additionally on the first component 3.

The first magnetic means 8 and/or the second magnetic means 9 may comprise at least one, preferably a plurality of, magnetic element(s) 11, 12, 13, 14, 15, 16, wherein the at least one magnetic element 11, 12, 13, 14, 15, 16 has an elongate shape with a longitudinal axis 17, wherein the longitudinal axis 17 encloses an angle α between 5° and 175°, preferably 40° and 140°, particularly preferably 60° and 120°, most preferably 70° to 110°, with the first axis 6, cf. FIGS. 2, 4 and 6. Due to an inclined position of the magnetic element 11, 12, 13, 14, 15, 16, the value of the angle α of 90°, preferably the value range of 87.5° to 92.5°, must be excluded from the aforementioned value ranges of the angle α. FIGS. 4 and 6 only show the receiving holes 30 for receiving the magnetic elements 11, 12, 13, 14, 15, 16, but since these are adapted to the geometry of the magnetic elements 11, 12, 13, 14, 15, 16, the oblique arrangement of the elongated magnetic elements 11, 12, 13, 14, 15, 16 relative to the first axis 6, in particular to the vertical axis, is apparent. This inclined arrangement makes it possible for an alignment of the magnetic field emanating from the magnetic elements 11, 12, 13, 14, 15, 16 to perform a support component in a downward and radially outward direction.

The first magnetic means 8 and/or the second magnetic means 9 can or can comprise at least one, preferably a plurality, of magnetic elements 11, 12, 13, 14, 15, 16, wherein the at least one magnetic element 11, 12, 13, 14, 15, 16 has an elongate shape with a longitudinal axis 17, wherein the longitudinal axis 17 is aligned at an angle to β a horizontal line 18 and the angle β is between 1.5° and 45°, preferably 2° and 35°, particularly preferably 5° and 30°, most preferably 10° to 25°, further preferably 12.5° and 20.0°. This inclined alignment of the magnetic elements 11, 12, 13, 14, 15, 16 on the tone arm body or to a horizontally extending plane or to a plane extending perpendicular to the first axis 6 (axis of rotation and vertical axis) results in an advantageous configuration of the magnetic field stabilizing the tone arm holding body.

The tone arm holding body 4 can, for example, have a receiving space 19 for receiving a component of the bearing apparatus 5, wherein the receiving space 19 is delimited by a wall portion 20 of the tone arm holding body 4 and the first magnetic means 8 is arranged or formed at least in portions, preferably predominantly, particularly preferably completely, on, i.e. for example in or on, a wall portion 20. The receiving space 19 or the recess of the tone arm holding body 4 can, for example, have a cylindrical, in particular circular-cylindrical, basic shape. The shell surface of this cylindrical, in particular circular-cylindrical, basic shape can be limited by the wall portion 20, wherein the magnetic elements 11, 12, 13, 14, 15, 16 for forming the first magnetic means 4 are arranged or formed on this wall portion 20, preferably on the radially outwardly facing surface of the wall portion 20. The first magnetic means 8 can, for example, be arranged or formed at least in portions, preferably predominantly, particularly preferably completely, on an edge area of the wall portion 20 associated with an opening 21 of the receiving space 19, see FIG. 6.

The receiving space 19 of the tone arm holding body 4 can be used to receive a component of the first component 3. Preferably, the receiving space 19 is delimited by a wall portion 20 of the tone arm holding body 4, wherein the wall portion 20 is arranged at least in portions in a receiving recess 10 of the first component 3, cf. FIGS. 1 and 5. In other words, both a portion of the tone arm holding body 4 engages in a receiving recess 10 of the first component 3 and a portion of the first component 3 engages in the receiving space 19 of the tone arm holding body 4.

The first magnetic means 8 and/or the second magnetic means 9 can comprise at least two magnetic elements 11, 12, 13, 14, 15, 16 designed as permanent magnets. Preferably, all magnetic elements 11, 12, 13, 14, 15, 16 of the first and/or second magnetic means 8, 9 are designed as permanent magnets.

The invention further comprises a method for mounting a tone arm 2, in particular a tone arm 2 of a record player, by means of a device 1 described herein. First, a first component 3 is provided, wherein a second magnetic means 9 is arranged or formed on the first component 3, and a tone arm holding body 4 is provided, wherein a first magnetic means 8 is arranged or formed on the tone arm holding body 4. Further, the tone arm holding body 4 is arranged in such a way that the tone arm holding body 4 is mounted on a bearing apparatus 5 and that the first magnetic means 8 and the second magnetic means 9 interact with one another via a magnetically attracting and/or repelling magnetic force.

### LIST OF REFERENCE SIGNS

1 device
2 tone arm
3 first component
4 tone arm holding body
5 bearing apparatus
6 first axis (e.g. vertical axis)
7 second axis (e.g. horizontal axis)
8 first magnetic means of 4
9 second magnetic means of 3
10 receiving recess of 3
11 first magnetic element
12 second magnetic element
13 third magnetic element
14 fourth magnetic element
15 fifth magnetic element
16 sixth magnetic element
17 longitudinal axis of 11, 12, 13, 14, 15, 16
18 horizontal line
19 receiving space of 4
20 wall portion of 4 (which limits 19)
21 opening of 19
22 bearing needle
23 bearing base body
24 bearing needle receptacle
25 tone arm receptacle of 4
26 lower edge of 4
27 radial outer upper edge of 3
28 radial inner upper edge of 3
29 aperture of 3
30 receiving hole of 4
31 straight line
32 first group of magnetic elements 11, 12, 13
33 second group of magnetic elements 14, 15, 16
α angle between 17 and 6
β angle between 17 and 18

What is claimed is:

1. A device for mounting a tone arm, in particular a tone arm of a record player, with
a first component and
a tone arm holding body which is mounted via a bearing apparatus so as to be rotatable about a first axis and pivotable relative to the first component about a second axis, wherein
at least one first magnetic means is arranged or formed on the tone arm holding body and at least one second magnetic means is arranged or formed on the first component, wherein the first magnetic means and the second magnetic means interact with one another via a magnetically attracting and/or repelling magnetic force.

2. The device according to claim 1, wherein the first component is arranged below the tone arm holding body.

3. The device according to claim 1, wherein the first component is formed at least in portions preferably predominantly, particularly preferably completely, as a second magnetic means.

4. The device according to claim 1, wherein the first component has a receiving recess into which the tone arm holding body can be received at least in portions.

5. The device according to claim 4, wherein the receiving recess is designed as a ring groove, in particular as a circular ring groove.

6. The device according to claim 1, wherein the first component is designed as a circular ring-shaped body, preferably the first component is designed as a circular ring-shaped body.

7. The device according to claim 1, wherein the first component is arranged or formed immovably or rigidly with a bearing apparatus.

8. The device according to claim 1, wherein the first magnetic means and/or the second magnetic means comprises at least two magnetic elements.

9. The device according to claim 1, wherein
at least a first and a second magnetic element of the first magnetic means or
at least a first and a second magnetic element of the second magnetic means
are arranged or designed symmetrically to one another, in particular point-symmetrically and/or mirror-symmetrically.

10. The device according to claim 1, wherein the first magnetic means and/or the second magnetic means comprises at least one, preferably a plurality of, magnetic element, wherein the at least one magnetic element has an elongated shape with a longitudinal axis, wherein the longitudinal axis includes an angle α between 5° and 175°, preferably 40° and 140°, particularly preferably 60° and 120°, most preferably 70° to 110°, with the first axis.

11. The device according to claim 1, wherein the first magnetic means and/or the second magnetic means comprises at least one, preferably a plurality of, magnetic element, wherein the at least one magnetic element has an elongated shape with a longitudinal axis wherein the longitudinal axis is aligned at an angle β to a horizontal line and the angle β is between 1.5° and 45°, preferably 2° and 35°, particularly preferably 5° and 30°, most preferably 10° to 25°, further preferably 12.5° and 20.0°.

12. The device according to claim 1, wherein the tone arm holding body comprises a receiving space for receiving a component of the bearing apparatus, wherein the receiving space is delimited by a wall portion of the tone arm holding body and the first magnetic means is arranged or formed at least in portions, preferably predominantly, particularly preferably completely, on a wall portion, in particular the first magnetic means is arranged or formed at least in portions, preferably predominantly, particularly preferably completely, on an edge area of the wall portion associated with an opening of the receiving space.

13. The device according to claim 1, wherein the tone arm holding body has a receiving space for receiving a component of the first component, preferably the receiving space is delimited by a wall portion of the tone arm holding body, wherein the wall portion is arranged at least in portions in a receiving recess of the first component.

14. The device according to claim 1, wherein the first magnetic means and/or the second magnetic means comprises at least two magnetic elements designed as permanent magnets, preferably all magnetic elements of the first and/or second magnetic means are designed as permanent magnets.

15. The device of claim 1, wherein the first axis is a vertical axis.

16. The device of claim 1, wherein the second axis is a horizontal axis.

17. A method for mounting a tone arm of a record player, by means of a device according to claim 1, with the method steps:
providing a first component, wherein a second magnetic means is arranged or formed on the first component;
providing a tone arm holding body, wherein a first magnetic means is arranged or formed on the tone arm holding body;
arranging the tone arm holding body in such a way that the tone arm holding body is mounted on a bearing apparatus and that the first magnetic means and the second magnetic means interact with one another via a magnetically attracting and/or repelling magnetic force.
